(19) United States
(12) Patent Application Publication
(10) Pub. No.: US 2003/0079963 A1
(43) Pub. Date: May 1, 2003

(54) Device for conveying separated objects

(76) Inventor: Thomas Zimmermann, Berlin (DE)

Correspondence Address: McGLEW AND TUTTLE, P.C., SCARBOROUGH STATION, SCARBOROUGH, NY, 10510-0827, US

(21) Appl. No.: 10/280,776

(22) Filed: Oct. 25, 2002

(30) Foreign Application Priority Data
Oct. 26, 2001 (DE) 101 52 327.0

(51) Int. Cl. B65G 29/00

(52) U.S. Cl. 198/620

(57) ABSTRACT

A device for conveying separated objects (1), especially disk-shaped objects, such as coins, includes a guideway (2) and with a lamellar belt (4) circulating on a conveying arm (3), wherein a strand (5) of the lamellar belt (4) facing the guideway (2) is guided over the entire longitudinal extension of the conveying arm (3), providing that lamella tips (6) of the lamellar belt (4) pointing toward the guideway (2) have a distance A from the guideway (2) that is smaller than the smallest height of an object (1) over the guideway (2). A support feature (8) for supporting the lamella tips (6) in the direction at right angles to the direction of conveying is installed at least in an intake area (7) of the conveying arm (3).

### FIELD OF THE INVENTION

The present invention pertains to a device for conveying separated objects, especially disk-shaped objects, such as coins, with a guideway and with a lamellar belt circulating on a conveying arm, wherein a strand of the lamellar belt facing the guideway is guided over the entire longitudinal extension of the conveying arm, providing that the tips of the lamellae of the lamellar belt pointing toward the guideway have a distance A from the guideway that is smaller than the smallest height of an object over the guideway. In such a device, the objects are grasped by the strand of the lamellar belt facing the guideway and are conveyed on the guideway. This takes place especially due to the action of the tips of the lamellae. The static friction and/or sliding friction forces between the objects and the tips of the lamellae or the lamella flanks directly adjoining same are greater than the static friction and/or sliding friction forces between the objects and the guideway. The objects that can be conveyed within the framework of the present invention usually have a disk shape, and one principal surface of the disk slides on the guideway and the opposite principal surface is grasped by the lamellar belt. A guideway may be designed, e.g., as a sorting plate. The present invention also pertains to the use of such a device as well as to a process for conveying coins using such a device.

### BACKGROUND OF THE INVENTION

A device of the design described in the introduction has been known from the literature reference DE 199 57 482 A1. The conveying device thus known has proved to be successful, in principle. A need for improvement arises from the relationships explained below. A so-called rotary table is typically arranged upstream of the conveying means. This rotary table feeds coins to the conveying device while they are being separated by suitable vertical and lateral guide plates, an intake area of the conveying arm reaching up to the rotary table or partially overlapping same. The guideway reaching up to the rotary table typically has a stop edge or stop roller, around which a coin having passed over from the rotary table onto the guideway is guided in an arc segment path. This technology has been commonly used for many years and is certainly known to the average person skilled in the art, so that an in-depth explanation is unnecessary. A special problem, which does not occur in the case of the use of a conventional conveying belt, e.g., one designed as a V-belt, arises in connection with the use of a lamellar belt. Since the lamellae are always relatively elastic and have low dimensional stability due to their slender design, they are bent not only in the direction opposite the direction of conveying in the intake area. A bending moment or a moment of tilt in the direction at right angles to the direction of conveying will rather act in the intake area due to the arc segment-shaped guiding of the coin. As a result, tilting of the lamellar belt may occur. This may, furthermore, cause the coins not to be guided reliably in the intake area along a stop edge of the guideway. This is disturbing especially because a sensor system for detecting coin diameters, which uses the stop edge as a reference point, is typically installed in the intake area or in the area directly adjoining same. This may ultimately lead to errors in the detection of the value of a coin being conveyed.

### SUMMARY OF THE INVENTION

The basic technical object of the present invention is therefore to provide a device for conveying separated objects that guarantees the reliable guiding of the objects in the intake area.

To accomplish this technical object, the present invention provides means for supporting the tips of the lamellae in the direction at right angles to the direction of conveying that are installed at least in an intake area of the conveying arm. The supporting means guarantees that the tips of the lamellae are supported at right angles to the direction of conveying against a moment generated during the circulation of the stop edge or stop roller. The present invention may be used, in principle, for a great variety of designs of the lamellar belt. A lamellar belt is, in principle, a conveying belt that has a continuous, especially uniform succession of lamellae (or fingers) projecting at right angles or in a bent manner and are arranged at the base of the belt on its side running against the guideway. Within the framework of the present invention, the terms lamellar belt or lamellae also comprise embodiments with knobs or protruding portions arranged regularly or irregularly laterally (at right angles to the longitudinal extension of the belt), e.g., in a cylindrical design. The lamellae may be bent against the direction of conveying or in the direction of conveying. The form of the lamellae is, in principal, freely selectable. They may be designed, e.g., as centrally symmetrical lamellae with an essentially triangular design (relative to a plane located at right angles to the guideway and extending in the direction of conveying), wherein the tips of the lamellae are rounded. In their extension at right angles to the direction of conveying, the lamellae may extend at right angles to the direction of conveying (continuously) or be arranged at an angle of incidence hereto (in case of the knobs, rows of knobs may be arranged at right angles or at an angle of incidence). The latter is especially advantageous for guiding the objects along the stop edge. The angle of incidence, measured between the longitudinal extension of the conveying belt and the transverse extension of the lamellae, specifically on the side in the direction of running of the conveying belt, may be smaller than 90°, e.g., 80-89.5°. Lamellae are typically rubber-elastic or spring-elastic. The distance A may be zero, i.e., the tips of the lamellae touch the guideway. In case of the conveying of coins, a distance A in the range of 0 mm to 2 mm, preferably 0 mm to 1 mm, and especially 0 mm to 0.5 mm or 0 mm to 0.1 mm is recommended. Concerning details of the design of suitable lamellae, reference is additionally made expressly to the literature reference DE 199 57 482 A1. This also applies to the drive-side design of the lamellar belt as a V-belt, flat belt or toothed belt as well as the introduction of possible reinforcing elements.

It is achieved with the present invention that coins will run reliably at the stop edge especially in the intake area and, e.g., the coin diameter is consequently detected with improved reliability. Errors in measurement and consequently missorting are practically ruled out as a result.

The present invention may be used, in principle, with any desired form of guiding of the lamellar belt on the conveying arm. For example, guide elements may be used for the lamellar belt, which have a U- or H-shaped cross section to the longitudinal extension of the conveying arm, the lamellar belt being guided by webs laterally on both sides, relative to the lamellar belt. The lamellar belt slides on a support surface between the webs. It is also possible to install a plurality of conventional guide rollers along the conveying arm. These may be guided and suspended in the known manner elastically with a force component toward the guideway. Deflecting rollers arranged at the end of the conveying arm are thus also guide rollers in the sense of this description.

In the simplest case, the supporting means may be a guide edge arranged at the guideway, and the height of the guide edge is greater than the distance A. The guide edge is now located, of course, on the side of the guideway located opposite the stop element of the guideway. Supporting of the tips of the lamellae against force components directed at right angles to the direction of conveying and pointing away from the guide edge is thus achieved.

As an alternative or in addition, the supporting means may comprise a flanged-coupling pulley of a guide roller, wherein the radius R of the flanged-coupling pulley equals at least the distance S1 between a lamella base and the axis of rotation of the flanged-coupling pulley. A plurality of flanged-coupling pulleys may also be provided at a plurality of guide rollers. A guide roller may have flanged-coupling pulleys on both sides. It is essential that such a flanged-coupling pulley be provided on the side of a guide roller located opposite the stop edge. A flanged-coupling pulley may reach up to the guideway and even extend past same laterally. However, the radius R of the flanged-coupling pulley is preferably smaller than the distance S2 between the guideway and the axis of rotation of the flanged-coupling pulley.

The flanged-coupling pulley may, in principle, rotate in unison. However, the flanged-coupling pulley is preferably connected to the guide roller and rotates together with same. An advantageous additional effect is created in this case, because the outer circumferential velocity of the flanged-coupling pulley is now greater than the (mean) linear velocity of the tips of the lamellae, as a consequence of which the side of the tips of the lamellae, which is supported by the flanged-coupling pulley, is bent in the direction of conveying. As a result, even a force component in the direction of the stop edge is ultimately generated for the coins being conveyed.

Especially in the intake area, a plurality of adjacent guide rollers may be provided with a flanged-coupling pulley each. Because of the high requirements imposed on reliable guiding, guide rollers with relatively short distances between their axes are installed in the intake area (and consequently in the detector area). The minimum attainable axial distance is now determined by the diameter of a flanged-coupling pulley. However, it may be desirable to make the axial distance even smaller than the diameter of a flanged-coupling pulley. A preferred embodiment is therefore characterized in that the sum of the outer radii R of two adjacent flanged-coupling pulleys is greater than the distance of the axes of rotation of the flanged-coupling pulleys, the flanged-coupling pulleys rotating at a lower angular velocity and the flanged-coupling pulleys having outer teeth meshing with each other. The outer teeth guarantee reliable support of the tips of the lamellae and they make it possible at the same time to arrange the axes of rotation of the flanged-coupling pulleys especially close to each other because of their meshing action.

The present invention teaches, furthermore, the use of a device of the above-described design for conveying coins in the horizontal and/or vertical and/or oblique direction, optionally with arc segment-shaped, especially circle arc-shaped transition areas, as well as the use of such a device for counting and/or sorting coins.

Finally, the present invention provides a process for conveying objects, wherein the objects run into the guideway along an arc segment-shaped path in the intake area of a conveying device of the above-described design, wherein the outer circumferential velocity of the flanged-coupling pulley arranged opposite the stop element in relation to the guideway is greater than the mean linear velocity of the tips of the lamellae, and wherein the objects are acted on by the tips of the lamellae with a force component acting at right angles to the direction of conveying and toward a stop edge of the guideway that is located opposite the flanged-coupling pulley.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a schematic view showing a lamellar belt used within the framework of the present invention as well as the function thereof;

FIG. 2 is a schematic view of the kinematic relationships during the passage of a coin from a rotary table onto a guideway;

FIG. 3A is a side view of an embodiment with flanged-coupling pulleys;

FIG. 3B is a cutaway end view of the embodiment of FIG. 3A;

FIG. 4 is a schematic top view of the subject of FIG. 3A,

FIG. 5A is a top view of an embodiment with a guide edge; and

FIG. 5B is a sectional end view of an embodiment with a guide edge.

DESCRIPTION OF THE PREFERRED EMBODIMENTS

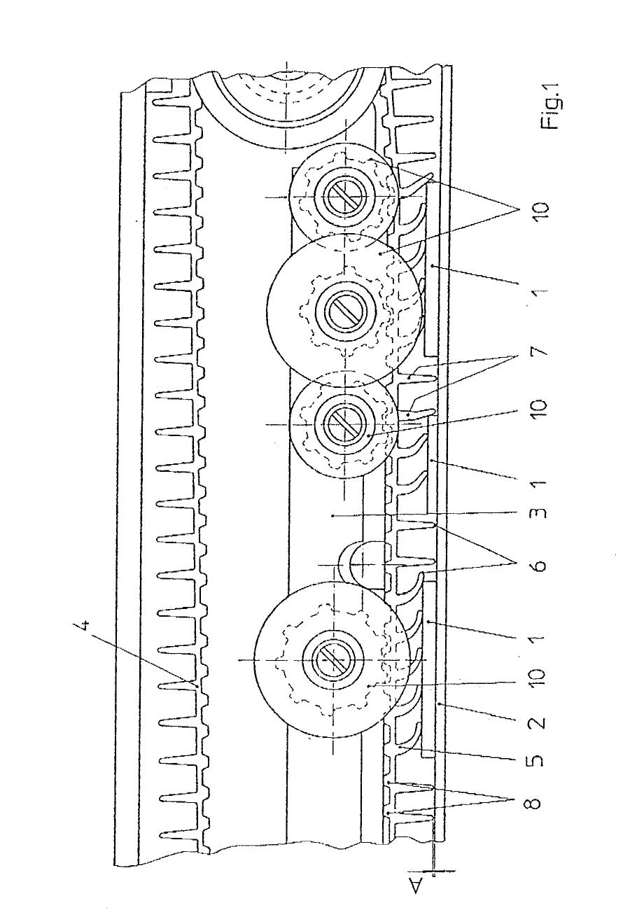

Referring to the drawings in particular, FIG. 1 shows separated coins 1, which are being guided on a guideway 2. A lamellar belt 4 circulates on a conveying arm 3. The strand 5 of the lamellar belt 4 facing the guideway 2 is guided by means of the guide rollers 10, providing that lamella tips 6 of the lamellar belt 4 pointing toward the guideway 2 have a distance A from the guideway 2 that is smaller than the smallest height of an object 1 over the guideway 2. In the view shown in FIG. 1, the objects or coins are being conveyed from right to left. Two flanged-coupling pulleys 9 with larger diameters can be recognized as supporting means.

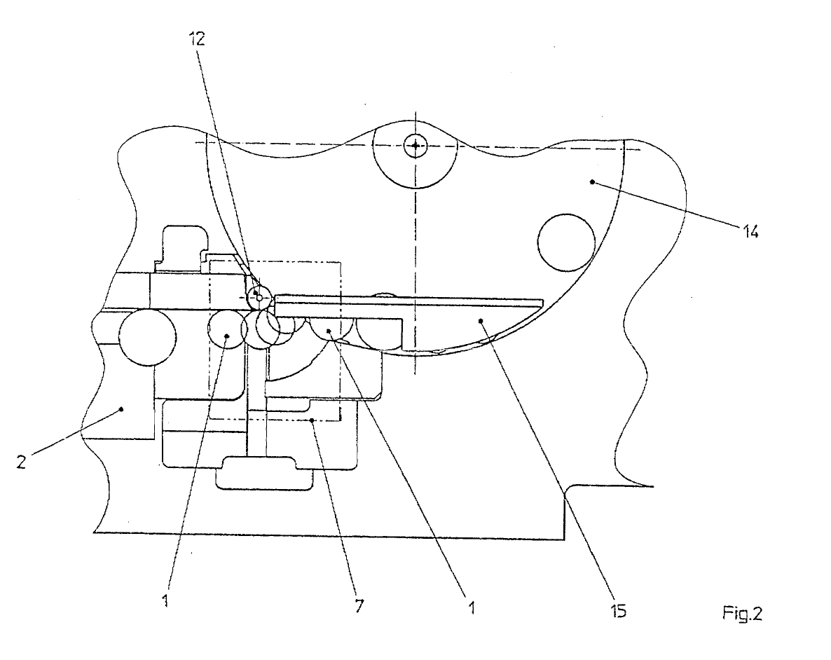

FIG. 2 shows the kinematics of an individual coin 1 during the passage from a rotary table 14 onto the guideway 2. It is recognized that the coin 1 is separated on the rotary table by means of a stationary separating element 15. Additional separating elements may also be provided as a height limitation for the purpose of separation. In the area after the separating element 15, the coin 1 circulating on the rotary table 14 first meets a stop element 12, which may be designed as an edge or roller. It is recognized in FIG. 2 that the coin will then run first around the stop element 12 along a circle arc segment and is conveyed essentially linearly only upon entry on the guideway 2. The conveying arm 3 with the lamellar belt 4 is not shown in FIG. 2 for clarity's sake. The intake area 7 of the conveying arm extends up to the rotary table 14.

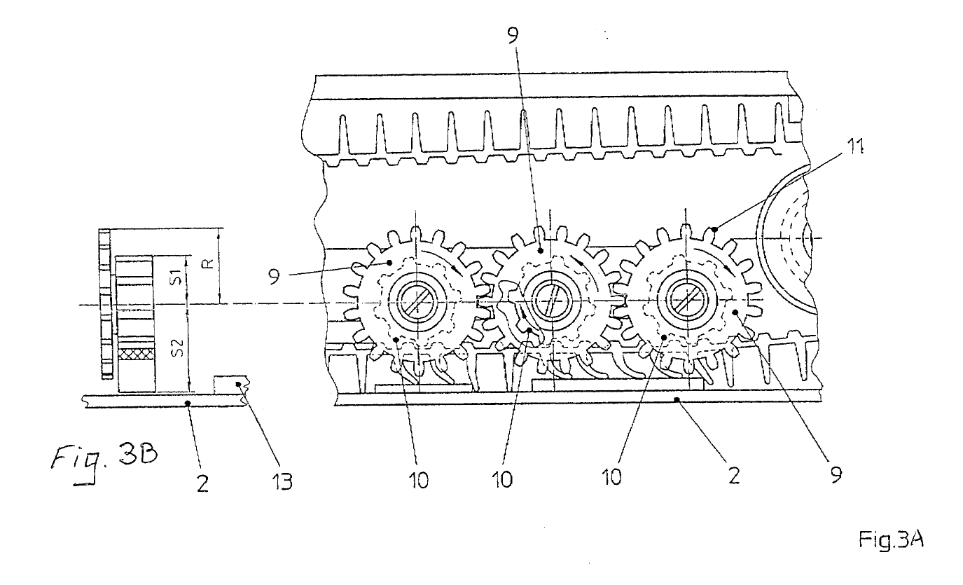

FIGS. 3A and 3B show an embodiment of the present invention with toothed flanged-coupling pulleys 9 meshing with each other on adjacent guide rollers 10. The flanged-coupling pulleys 9 are arranged on the side of the guide rollers 10 located opposite the stop edge 13 relative to the guideway 2. It is seen that the sum of the outer radii R of two adjacent flanged-coupling pulleys 9 is greater than the distance between the axes of rotation of the flanged-coupling pulleys 9. Due to the fixed connection to its guide rollers 10, at least one flanged-coupling pulley 9 rotates at equal angular velocity, and the flanged-coupling pulleys 9 have outer teeth 11, which mesh with each other. The radius R of the flanged-coupling pulley 9 is greater than the distance S1 between a lamella base and the axis of rotation of a flanged-coupling pulley 9 (see FIG. 3B). The radius R of the flanged-coupling pulley 9 is, furthermore, smaller than the distance S2 between the guideway 2 and the axis of rotation of the flanged-coupling pulley 9.

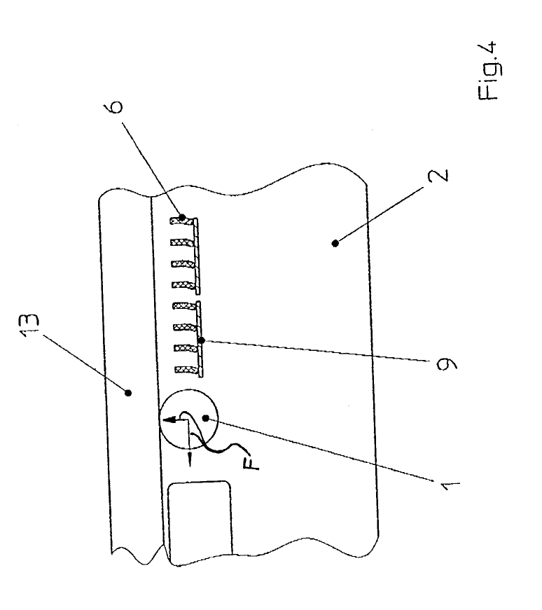

The mode of action of the embodiment according to FIG. 1 is schematically explained in FIG. 4. Since the outer circumferential velocity of the flanged-coupling pulley 9 is greater than the mean linear velocity of the lamella tips 6, the side of the lamella tips 6 supported by the flanged-coupling pulley 9 is bent forward in the direction of conveying. This ultimately causes the coin 1 to be acted on by the lamella tips 6 with a force component directed at right angles to the direction of conveying and toward the stop edge 13 of the guideway 2 located opposite the flanged-coupling pulley 9. This is schematically indicated by the force arrows F.

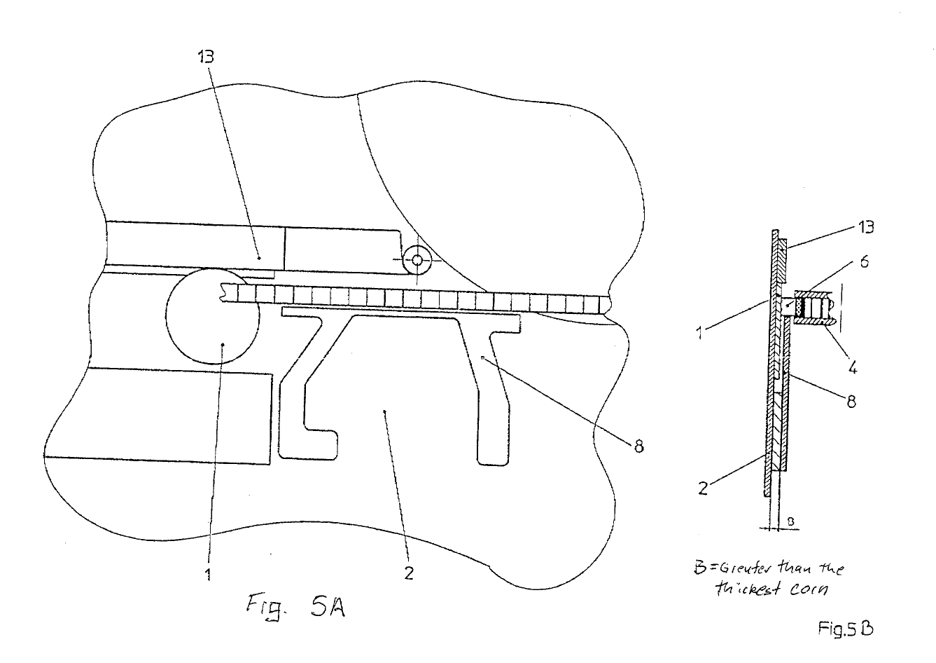

FIGS. 5A and 5B show an embodiment of the present invention, in which the supporting means 8 are a (stationary) guide edge 8 arranged at the guideway 2, wherein the height of the guide edge 8 over the guideway 2 is greater than A. Using very simple means, an undesired tilting of the lamellar belt is reliably prevented from occurring with this embodiment. On the guideway side, the guide edge 8 may have a recess, whose height B (see FIG. 5B) over the guideway 2 is greater than the thickest coin to be conveyed.

While specific embodiments of the invention have been shown and described in detail to illustrate the application of the principles of the invention, it will be understood that the invention may be embodied otherwise without departing from such principles.

What is claimed is:

1. A device for conveying separated disk-shaped objects, the device comprising:
a guideway;
a lamellar belt;
a conveying arm, said lamellar belt circulating on said conveying arm, a strand of said lamellar belt facing said guideway being guided over an entire longitudinal extension of said conveying arm providing a distance A from said guideway to said said lamella tips of said lamellar belt pointing toward said guideway that is smaller than a smallest height of an object over said guideway; and
a means for supporting said lamella tips installed in a direction at right angles to a direction of conveying at least in an intake area of said conveying arm.

2. A device in accordance with claim 1, wherein said supporting means comprises a guide edge arranged at said guideway, wherein the height of the guide edge is greater than said distance A.

3. A device in accordance with claim 1, wherein said supporting means comprises a flanged-coupling pulley of a guide roller, wherein a radius of said flanged-coupling pulley equals at least a distance between a lamella base and an axis of rotation of said flanged-coupling pulley.

4. A device in accordance with claim 3, wherein said radius of said flanged-coupling pulley is smaller than a distance between said guideway and an axis of rotation of said flanged-coupling pulley.

5. A device in accordance with claim 3, wherein said flanged-coupling pulley is connected to said guide roller and rotates with same.

6. A device in accordance with claim 3, wherein a plurality of adjacent guide rollers are each equipped with one said flanged-coupling pulley.

7. A device in accordance with claim 6, wherein a sum of said outer radii of two said adjacent flanged-coupling pulleys is greater than a distance between the axes of rotation of said flanged-coupling pulleys, wherein said flanged-coupling pulleys rotate at equal angular velocity and wherein said flanged-coupling pulleys have said outer teeth meshing with each other.

8. A process for conveying separated disk-shaped objects, the process comprising:
providing a guideway;
providing a lamellar belt;
providing a conveying arm;
circulating the lamellar belt on the conveying arm with a strand of said lamellar belt facing said guideway and being guided over an entire longitudinal extension of said conveying arm and providing a distance from said guideway to said said lamella tips of said lamellar belt pointing toward said guideway that is smaller than a smallest height of an object over said guideway; and
supporting said lamella tips installed in a direction at right angles to a direction of conveying at least in an intake area of said conveying arm.

9. A process for conveying separated disk-shaped objects according to claim 8, further comprising:
conveying coins as the objects in a horizontal and/or vertical and/or oblique direction.

10. A process for conveying separated disk-shaped objects according to claim 8, wherein said conveying coins includes conveying with an one of an arc segment-shaped, circle-shaped or arc-shaped transition area.

11. A process for conveying separated disk-shaped objects according to claim 8, wherein the objects are coins and further comprising:
counting and/or sorting said coins.

12. A process for conveying objects, the process comprising:
providing a guideway;
providing a lamellar belt;
providing a conveying arm;
circulating the lamellar belt on the conveying arm with a strand of said lamellar belt facing said guideway and being guided over an entire longitudinal extension of said conveying arm and providing a distance from said guideway to said said lamella tips of said lamellar belt pointing toward said guideway that is smaller than a smallest height of an object over said guideway; and
supporting said lamella tips installed in a direction at right angles to a direction of conveying at least in an intake area of said conveying arm with a flanged-coupling pulley of a guide roller, wherein a radius of said flanged-coupling pulley equals at least a distance between a lamella base and an axis of rotation of said flanged-coupling pulley, wherein said objects enter said guideway in said intake area of a conveying device around a stop element along an arc segment-shaped path, wherein the outer circumferential velocity of said flanged-coupling pulley arranged opposite said stop element in relation to said guideway is greater than the mean linear velocity of said lamella tips, and wherein said objects are acted on by said lamella tips with a force component directed at right angles to the direction of conveying and toward a stop edge of said guideway located opposite said flanged-coupling pulley.
